(19) United States
(12) Patent Application Publication
(10) Pub. No.: US 2015/0017999 A1
(43) Pub. Date: Jan. 15, 2015

(54) METHOD OF COGNITIVE RADIO AND DEVICE UTILIZING THE SAME

(71) Applicant: MediaTek Singapore Pte. Ltd., Singapore (SG)

(72) Inventors: Zhong Chen, Beijing (CN); I-Kang Fu, Taipei City (TW)

(21) Appl. No.: 14/375,833

(22) PCT Filed: Feb. 27, 2013
(86) PCT No.: PCT/CN2013/071956

§ 371 Date: Jul. 31, 2014

(30) Foreign Application Priority Data
Feb. 27, 2012 (CN) 201210046625.2

(51) Int. Cl. H04W 72/04; H04W 88/08

(52) U.S. Cl. CPC H04W 72/0453; H04W 88/08
USPC 455/452.1

(57) ABSTRACT

A method of implementing a cognitive radio (CR) technology and a device utilizing the same are provided. The method includes: when a first base station meets a requirement for entering a cognitive radio (CR) state, acquiring information on a potential frequency band which is assigned to a second base station; performing a band selection based on the potential frequency band to select a desired frequency band; and entering the CR state by accessing the first base station using the desired frequency band.

### CROSS REFERENCE TO RELATED APPLICATIONS

This application is a National Phase of PCT/CN2013/071956, filed Feb. 27, 2013, which claims the benefit of Chinese Application No. 201210046625.2 filed Feb. 27, 2012. The contents of these priority applications are hereby incorporated by reference.

### FIELD OF THE INVENTION

The present invention relates to a 3GPP Long Term Evolution (LTE) mobile communication system, and in particular, relates to a Cognitive Radio (CR) method implemented in an LTE system.

### RELATED ART

In the past 10 years, with the ever increasing popularity of mobile phones, newly developed technologies have led to a considerable growth in mobile communications. There has been an increase in the data throughput of mobile communications by 5 to 50 times from 10 years ago. In the next 10 years, it is predicted that the data throughput of mobile communications will continue to grow significantly, with the growth in handheld equipment and mobile internet access being the key driving forces.

Network capacity poses a primary concern in the development of the data throughput of mobile communications. The utilization of a majority of the authorized spectrums or frequency bands (such as the radar spectrum) remains low, typically less than 1%. Meanwhile, under present policies, unauthorized users are not allowed to use unauthorized spectrums.

### BRIEF SUMMARY OF THE INVENTION

Therefore, methods and devices utilizing the cognitive radio technology in LTE system are provided.

An embodiment of a method of implementing a cognitive radio (CR) technology is provided. When a first base station meets a requirement for entering a cognitive radio (CR) state, information is acquired on a potential frequency band which is assigned to a second base station. A band selection is performed based on the potential frequency band to select the desired frequency band. The CR state is entered by accessing the first base station using the desired frequency band.

Another embodiment of a device adopting a cognitive radio (CR) technology is provided, comprising a first element management unit, a network management unit and a second element management unit. When a first base station meets a requirement for entering a CR state, the first element management unit transmits a request for entering the CR state. The network management unit, coupled to the first element management unit, receives the request for entering the CR state from the first element management unit. The second element management unit, coupled to the network management unit and the first element management unit, acquires information on a potential frequency band which is assigned to a second base station. The network management unit performs a band selection based on the potential frequency band to select the desired frequency band, and responds to the request for entering the CR state, enabling the first base station to enter the CR state and establishing a connection using the desired frequency band.

In some embodiments, the method comprises initiating a new cell using one of the potential frequency bands after the first base station enters the CR state, and receiving the signal from the base station by the terminal, the original cell, and the new cell. In other embodiments, the method comprises: after the first base station enters the CR state, initiating a new cell by using one of the potential frequency bands, and switching the serving cell for the terminal to the new cell to employ the new cell as the serving cell. In some other embodiments, the method comprises: before the first base station enters the CR state, the first base station switching the serving cell of the service terminal to a neighboring cell, when entering the CR state, the first base station terminate the original serving cell, and after entering the CR state, initiating a new cell by using one of the potential frequency bands, switching the serving cell of the terminal to the new cell to utilize the new cell to provide services to the terminal.

Through the invention, the cognitive radio technology for the LTE mobile communication system can be realized under the insufficient spectrum condition, resolving the issue of insufficient network capacity, and providing technology supports for mobile communication systems to use other unauthorized frequency bands.

The following details embodiments and advantages of the invention. The scope of the invention is not limited to the disclosure, and is defined by the appended claims.

### BRIEF DESCRIPTION OF THE DRAWINGS

FIG. 1 is a block diagram of a communication device 1 according to an embodiment of the invention.

FIG. 2 is a schematic diagram of a localized network topology 2 according to an embodiment of the invention.

FIG. 3 shows a distributed network topology 3 with no interface between two networks.

FIG. 4 shows a distributed network topology 4 with a communication interface ltf-S between two networks.

FIG. 5 is a message flow chart of a CR method 5 according to an embodiment of the invention.

FIG. 6 is a message flow chart of a CR method 6 according to an embodiment of the invention.

FIG. 7 is a message flow chart of a CR method 7 according to an embodiment of the invention.

FIG. 8 is a message flow chart of a CR method 8 according to an embodiment of the invention.

FIG. 9 is a message flow chart of a CR method 9 according to an embodiment of the invention.

FIG. 10 is a flowchart of a carrier aggregation method 10 according to an embodiment of the invention.

FIG. 11 is a flowchart of an inter-frequency handover method 11 according to an embodiment of the invention.

FIG. 12 is a flowchart of an inter-frequency switching method 12 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In 1999, a cognitive radio (CR) technology was introduced and defined as a radio system employing the technology which allows the system to acquire the information on the surrounding operations and geographical conditions, the established connecting strategy and the internal condition, dynamically and automatically adjust operation parameters and protocols to accomplish the predefined target according to the acquired information, and perform self-learning based on the acquired outcome. Several features of the cognitive radio technology are defined, including: sensing and acquiring the information on the surrounding and local radio environment, spectrum decision, communication system self-adjustment and performing further learning on the communication results.

Therefore, the cognitive radio technology can be employed to resolve the issue of limited channel capacity in the current LTE system. The cognitive radio technology increases the channel capacity in the communication system by fully utilizing the spectrum resource(s) in certain space range. In the present communication technologies, since it is a common practice to assigning the available spectrum resource by employing a specific communication technology in certain frequency bands and run by certain network operators, for example, the regulation defined the GSM system can be implemented in the 900 MHz and 1800 MHz frequency bands, other communication systems such as the UMTS system cannot use these frequency bands whether the 900 MHz and 1800 MHz frequency bands are in idle or not. Consequently the utilization rate of the spectrum resource is considerably wasted. For example, if scanning all frequency bands in certain place at certain time, it will be noted most frequency bands remain in the idle state without being fully utilized. The insufficient frequency bands refer to the frequency bands available to the communication system provided by a certain operator in certain place at certain time are fully occupied, resulting in the insufficiency of the frequency bands. However, if the limitation of the operators and the spectrum resource available to the specific communication system can be removed, then every telecom client may freely utilize all available spectrum resource(s) in certain space and time, and the network capacity may be increased.

The international Telecommunication Union Radio communication sector (ITU-R) decided on studying the cognitive radio technology in the world radio communication conference in 2007, introduces the issue 1.19, “Regulatory measures and their relevance to enable the introduction of software-defined radio and cognitive radio systems”, and initiates several study group to conduct studies on the subjects of “Regulatory measures and their relevance to enable the introduction of software-defined radio and cognitive radio systems”, “Spectrum management methodologies and economic strategies”, “Land mobile service above 30 MHz*(excluding IMT); wireless access in the fixed service; amateur and amateur-satellite services”, “Cognitive radio systems in the land mobile service”, and “Cognitive Radio Systems Specific to IMT Systems”. The study results will be discussed and confirmed in the world radio communication conference in 2012.

However, it should be noted, when different systems apply the CR technology, different system structure adjustment, protocol definition, and the control mechanism shared by the terminals and the network will be required. Presently, the LTE communication system has not yet supported the CR technology, subsequently, the CR technology may not be applied to the present mobile communication system to resolve the issue of the insufficient network capacity.

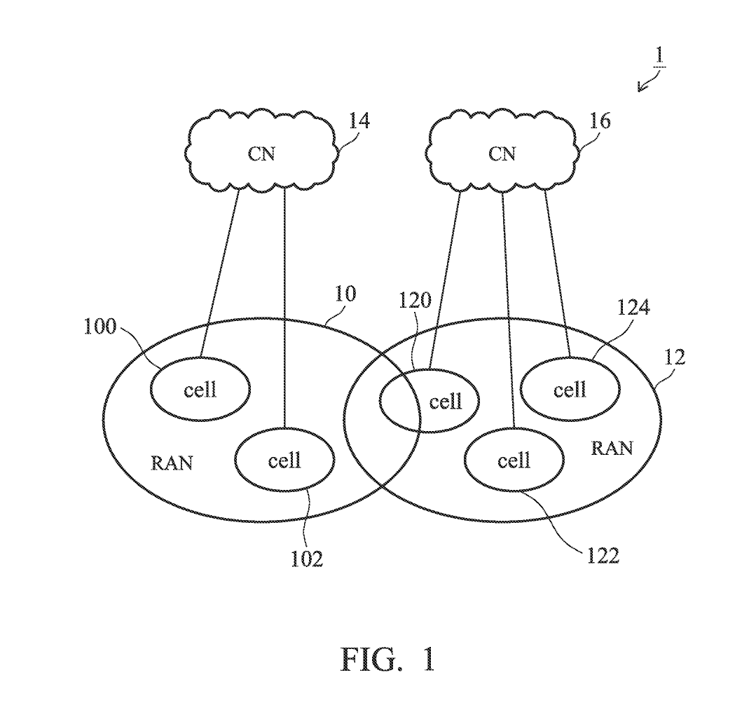

FIG. 1 illustrates a communication system 1 according to an embodiment of the invention, utilizing the CR technology disclosed in the invention. The communication system 1 is a Long Term Evolution (LTE) communication system, including Radio Access Networks (RAN) 10 and 12, and Core Networks (CN) 14 and 16. The CN 14 and 16 may be Evolved Packet Core (EPC) networks, which include a Mobility Management Entity (MME), a Serving GateWay (S-GW) and a Packet Data Network (PDN Gateway). The RAN 10 includes cells 100 and 102, the RAN 12 includes cells 120, 122 and 124. The RAN 10 and RAN 12 are coupled to the EPC 14. The radio coverage of the RAN 10 and RAN 12 are overlapped.

The RAN 10 and RAN 12 may be radio access networks of the same or different types, and may each belong to the same or different network operator or spectrum owner. In some embodiments, the RAN 10 and the RAN 12 belong to the same type of radio access network, e.g., the RAN 10 and the RAN 12 may belong to two Evolved Universal Terrestrial Radio Access Networks (hereinafter referred to as EUTRAN). In other embodiments, the RAN 10 and the RAN 12 may belong to different types of radio access networks, e.g., the RAN 10 may belong to the EUTRAN, and the RAN 12 may belong to the Universal Terrestrial Radio Access Network (hereinafter referred to as UTRAN). The CR technology may be used within the same RAN or between different RANs. In certain embodiments, the CR technology may be utilized between different cells in the same RAN. For example, the cell 100 may use a frequency band assigned to the cell 102. In other embodiments, the CR technology may be utilized for cells between two RANs. For example, the cell 102 in the RAN 10 may use a frequency band assigned to the cell 120 in the RAN 12. The two RANs may belong to the same or different spectrum owners. When the frequency bands assigned to a cell are fully occupied, the CR technology can be employed, using a spectrum sensing technique or a network negotiation technique to identify and determine which frequency band from the neighboring cells may be borrowed.

One embodiment of the invention provides an approach to implement the CR technology in an LTE system. The CR technology disclosed in the embodiment may be explained as follows. To begin, when the base station (such as eNodeB, referred to hereinafter as eNB) meets requirements for entering a CR state, the control center is configured to acquire the information on associated frequency bands, and then performs a band selection based on the information of the associated frequency bands to select the desired frequency band and a backup frequency band for network access, and determines whether the eNB is permitted to enter the CR state.

In the embodiments, of the invention, three system states are defined, namely: the entering the CR state, the in-CR state, and the leaving CR state.

For the entering the CR state, whether the CR technology should be activated can be determined according to a decision method of entering the CR state. On deciding upon activating the CR technology, the eNB is configured to enter the CR state, and searches for the desired frequency band for proceeding with spectrum access, while searching for another frequency band as the backup frequency band.

In the CR state, the eNB may employ techniques such as carrier aggregation (CA) to make use of the desired frequency band, while monitoring the utilization of the desired frequency band(s) in real time for the authorized user. In another embodiment, the eNB may utilize a band switching technique to make use of the other desired frequency bands.

In the leaving CR state, when the communication of the authorized user using the desired frequency band is affected, the eNB may select a second frequency band for the network access or leave the current desired frequency band for returning to the original state, without using a frequency band that is not assigned to the eNB in the very beginning.

Several network system topologies adopted by various embodiments of the invention are introduced as follows:

Network System Topologies

With a through study on the LTE mobile communication system and network topologies with functionality similar to CR, combining with the features of CR and the current LTE interface, the embodiments of the invention introduce localized and distributed network topologies as follows.

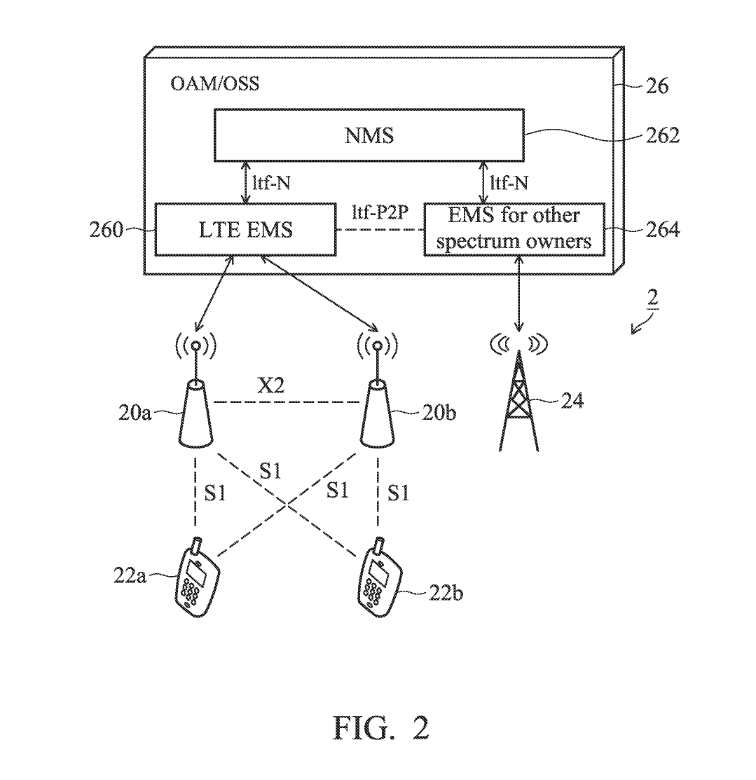

FIG. 2 is a schematic diagram of a localized network topology 2 according to an embodiment of the invention. The localized network topology 2 is implemented in the LTE mobile communication system, and includes base stations 20a, 20b and 24, an Operation Administration and Maintenance (OAM) 26, an Element Management System (EMS) 260, a Network Management System (NMS) 262, and an EMS for another operator 264, a Mobility Management Entity (MME) (not shown), a Service Gateway (S-GW) (not shown), and other functional entities. The NMS 262 (control center) in the network topology may be in communication with other communication systems through the interfaces ltf-S, ltf-N, ltf-P2P and S-GW. The base stations 20a and 20b belong to a network operator that is different from that of the base station 24, with the former base stations 20a and 20b being coupled to the EMS 260 and the latter base station 24 being coupled to the EMS 264. The EMS' 260 and 264 are coupled to the NMS 262, which is configured to manage and control the CR mechanism disclosed in the embodiments. The base stations 20a and 20b may communicate with each other through an interface X2. The two different EMS' 260 and 264 may communicate with each other through the interface ltf-P2P, and both may communicate to the NMS 262 through the interface ltf-N.

The localized network topology 2 utilizes the interface ltf-N to perform the CR function at the network management level by the NMS 262, or utilizes the interface ltf-P2P to perform the CR function at an element management level by the EMS 260. When performing the CR function at the network management level, the network management system 262 can receive an entering CR request via the interface ltf-N, and acquire all available information on the frequency bands from one or more EMS 264, thereby performing the CR function to select a frequency band to be used. When performing the CR function at the element management level, the NMS 262 can acquire all available information on the frequency bands, thereby performing the CR function to select a frequency band to be used.

In the localized network topology 2 shown in FIG. 2, the NMS 262, acting as a control center, controls the entire operation of the CR function. The control center may be integrated into an OAM, EMS, NMS, MME, S-GW, or other control entities, consequently the OAM, EMS, or MME may serve as the control center. The control center may comprise a data base, which is to collect and keep the information on the frequency bands sent from all other EMS'. In some embodiments, the EMS' 260 and 264 may also keep a copy of the received information on the frequency bands.

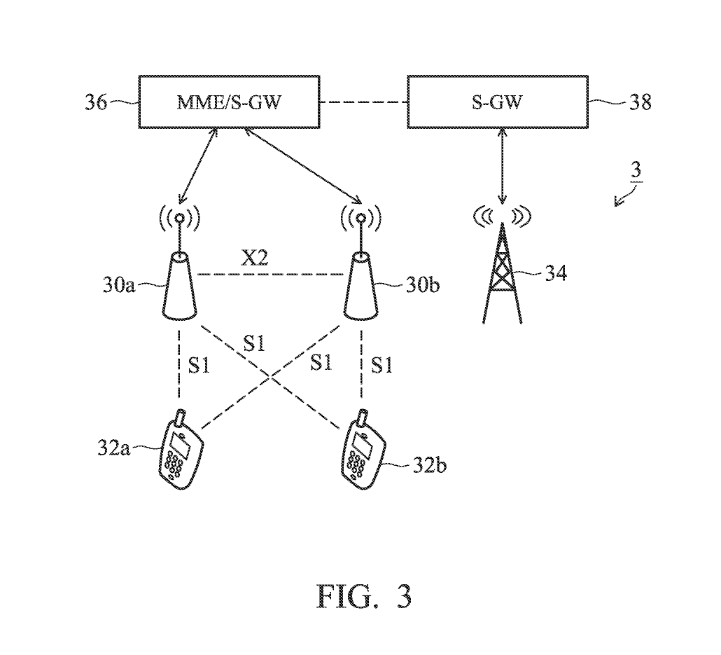

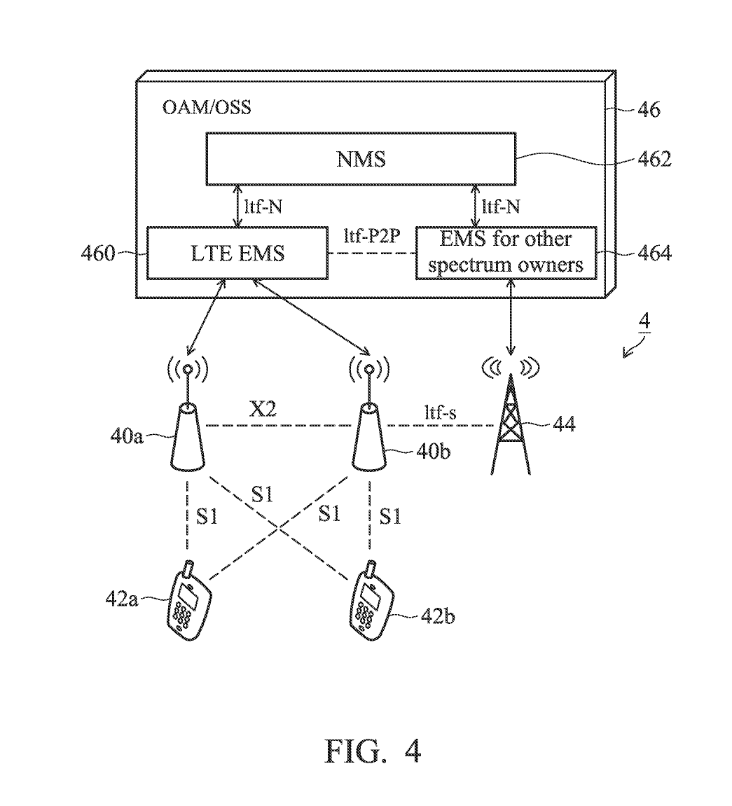

The distributed network topology as shown in FIGS. 3 and 4 may be integrated into an evolved Node B (referred to as eNB) via the control center, controlling the entire CR technology flow. Therefore, an eNB can also serve as a control center. Alternatively, all eNBs may be configured to use information of the CR technology. FIG. 3 shows a distributed network topology 3 with no interface between two networks. FIG. 4 shows a distributed network topology 4 with a communication interface ltf-S between two networks.

For the distributed network topology 3 in FIG. 3, since there is no interface between the base stations 30a and 30b and the base station 34, when performing the CR, the base stations 30a and 30b does not acquire information on the available frequency bands by way of communicating with the base station 34 or a database. Therefore, the base stations 30a and 30b have to adopt a frequency sensing approach to obtain the information on the available frequency bands, thereby selecting a frequency band to be used via the CR function.

For the distributed network topology 4 in FIG. 4, since the base stations 40a and 40b can directly communicate with the base station 44 by the interface ltf-S, thus, the base stations 40a and 40b may acquire the information on the available frequency bands of the base station 44 by exchanging signaling, and select the frequency band to be used using the CR function. The rest configuration and configuration of the distributed network topology 4 are similar to those in the network topology 2, therefore reference may be made to the previous paragraphs, and will be omitted here for brevity.

Although the embodiments in FIGS. 2 through 4 are implemented in the LTE communication system, those skilled in the art will recognize that the localized network topology 2 and the distributed network topologies 3 and 4 may also be integrated into other types of communication systems, such as GSM, CDMA, or TV systems.

Decision of Entering into the CR State

The control center can determine whether the eNB shall entre into the CR state based on the communication condition of the eNB, the surrounding band sensing information and the band access policy. That is, the control center can decide whether the eNB meets the requirement for entering the CR state. The communication condition(s) of the eNB includes loading, QoS, spectrum efficiency (in bps/Hz/m²), the number of the User Equipment (UE), signal quality on uplink and/or downlink transmission, and data throughput conditions. The surrounding band sensing information includes the loading of the target frequency band, the measurement results (such as RSSI and SINR) for the target frequency band taken by a service terminal, the information on the neighboring base station which uses the target frequency band, and the system parameters and configurations. The band access policy includes the information on the potential available target frequency bands, the criteria of using the target frequency band (such as the loading level and the measurement result), the criteria for exiting the target frequency band (such as the loading level and the measurement result), and the time information on the available frequency band.

In one embodiment, the following criteria are provided: first, when the loading exceeds a certain threshold; second, the QoS does not meet the requirements for all UEs; third, the utilization rate for the frequency band in use exceeds a threshold; and fourth, the number of the UEs in the eNB exceeds a threshold. When one or more criteria are met, and the met criteria cannot be resolved by a handover operation between the target eNB and the neighboring cell which is originally authorized for using the frequency band, the control center requests that the target eNB attempt to enter the CR state.

For the control center, it takes the surrounding band sensing information and the band access policy into account to determine whether the eNB should enter the CR state. The band information may be classified into 3 types according to the classification of the acquired band information.

Classification of the Acquired Band Information

In practice, the potential frequency bands which may be utilized by the LTE-based target eNB are classified into 3 types according to the classification of the acquired band information. The potential frequency bands which belong to the first category can acquire all information of the frequency bands through the interface of the control center or the terminal report, and are referred to as band1. The potential frequency bands which belong to the second category can acquire partial information of the frequency bands through the interface of the control center or the terminal report, and are referred to as band2. The acquired partial information includes the current utilization status, the radio coverage, and the transmit power. The potential frequency bands which belong to the third category cannot acquire information of the present frequency band through the interface of the control center or the terminal report due to lack of the interface between the equipments which use these frequency bands, and are referred to as band3. Nevertheless, the communication system can include a database which keeps historical records and processed statistical information for the frequency bands, including time distribution for which the frequency bands were occupied. In the frequency band classification, the first and second categories can acquire the frequency band information through the control center interface or the terminal report. In one embodiment, the frequency bands in the first and second categories have different priorities, wherein the category with a higher priority is selected for frequency band selection. For example, the frequency band in the second category will be selected for the frequency band selection only when no frequency band can be selected from the first category frequency band. In another embodiment, the control center can assign the priority to each frequency band.

Acquisition of the Acquired Band Information

The CR technology based on the LTE system requires considerable cognitive information. The following embodiment provides an approach for acquiring the cognitive information based on the present protocol, functional entities and infrastructure.

The cognitive information may include: the utilization the status of frequency band (being utilized or not), the radio coverage, the location of the base station, the band width, the in-band interference, the out-of-band tolerable interference, the idle period, the occupied period, the signal composition and the frame composition.

The approach for acquiring the information based on one protocol, functional entities and infrastructure may include the following. The band associated interference information obtained by the UE using a band sensing technique (such as the in-band interference and the out-of-band tolerable interference), the utilization status, and the band width, while acquiring information on the target frequency bands of neighboring base stations with the same or different network infrastructures. Thus, the cell eNB can interchange the information with the neighboring base stations. The control center or the eNB can acquire the frequency information of the neighboring system with a different network infrastructure through the ltf-s interface. The control center or the eNB can acquire the frequency information of the neighboring system with the same network infrastructure through the X2 interface. The EMS can acquire the frequency information of the neighboring system with a different network infrastructure through the ltf-P2P interface. The NMS can acquire the frequency information of the neighboring system with the same network infrastructure through the ltf-N interface.

The communication system can utilize a database for recording all CR information, which includes the information on all frequency bands and the history for the eNB which adopted the CR technique. The database may be located at a higher-layer network in the communication system, such as a functional entity including OAM, EMS, and EMS. All functional entities in the communication system can query, upload, or download from the database. The database may possess a data processing function, such as receiving and processing data of a large quantity, including data combining and error detection.

In another embodiment, in order to acquire the information on the potential accessible frequency bands, the base station may perform a measurement for the potential frequency band via the UE which may report the measurement report later. The protocols for entering the CR state according to different classifications of frequency bands are provided as follows.

Protocols for Entering the CR State

The frequency bands used in the communication system in the embodiment may be classified into 3 types, namely a type case1 which only includes the frequency bands band1 and band2, a type case2 which only includes the frequency band band3, and a type case3 which includes the frequency bands band1, band2 and band3. The distinction between the type case1 and type case2 is that the type case1 is able to acquire the full or partial information on the frequency band through the interface of the control center, whereas the type case2 cannot obtain the information on the frequency band through the interface of the control center. As for the type case3, it may be referred to as a “mixed” frequency band since the type case3 encompasses the conditions outlined in the type case1 and type case2.

The embodiments in the invention provide corresponding protocols for different types of frequency bands and different network infrastructures.

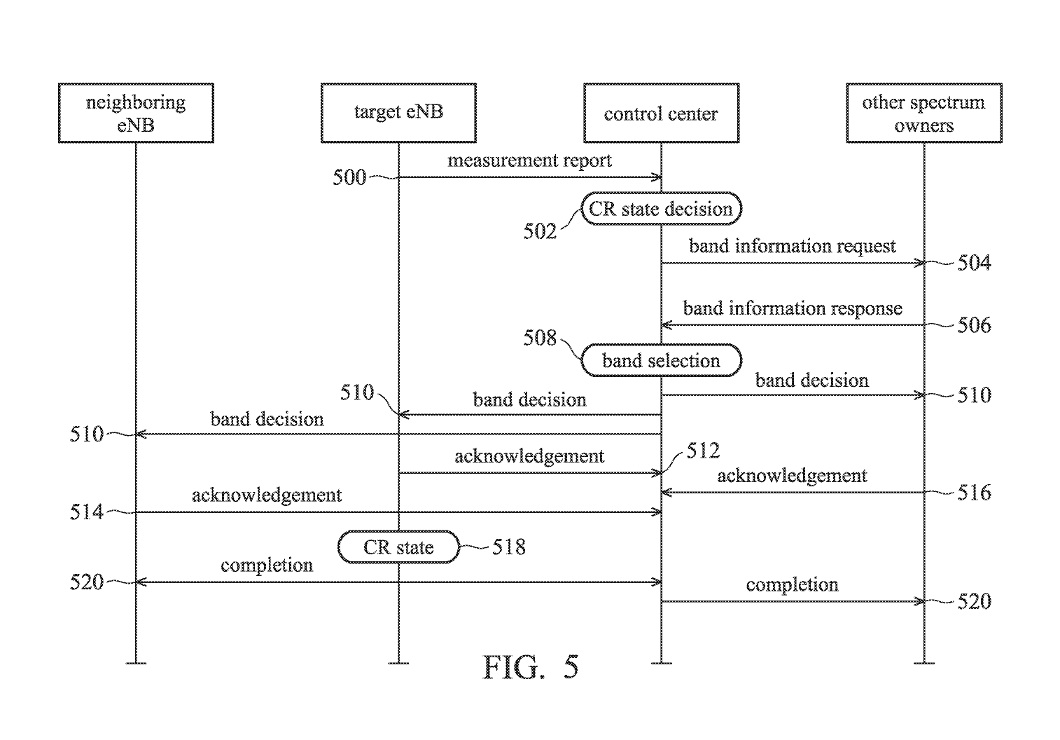

FIG. 5 is a message flow chart of a CR method 5 according to an embodiment of the invention, incorporating the localized structure in FIG. 2. The CR method 5 illustrated by the message flow chart represents how a localized network infrastructure including the LTE system and other systems enter the CR state, involving 4 entities, namely a neighboring eNB, a target eNB, an OAM/OSS/EMS control center, and another spectrum owner. The target eNB is a base station under observation. The neighboring eNB is a base station adjacent to the target eNB. The OAM/OSS/EMS control center manages a decision for entering the CR state and a selection for a borrowed frequency band. The other spectrum owner possesses the spectrum resource which the target eNB may borrow. With reference to the localized network infrastructure 2, the neighboring eNB may be that the base station 24, the target eNB may be that the base station 20, the OAM/OSS/EMS control center may be that the network management system 262, and the other spectrum owner may be that the EMS for the other operator 264. The neighboring eNB and the target eNB may belong to the same or different Radio Access Technology(ies) (RATs), also, the neighboring eNB and the target eNB may belong to the same or different network operator(s).

For the type case1 in the localized network infrastructure, the protocol for entering the CR state is shown in FIG. 5 and explained as follows:
To begin with, all eNBs in the localized network infrastructure can report the traffic condition in the cell. Take the target eNB as an example, the target eNB will send the traffic condition of the current cell in the form of, for example, a measurement report 500. The measurement report 500 may be generated by a measurement conducted by the target eNB itself, or measurements conducted by UEs within the radio coverage and then the measurements may be incorporated by the target eNB into the measurement report 500. The measurement report 500 may include the network loading and the other radio channel measurements.
For all eNBs adopting the CR technologies, the control center can detect whether the condition of entering the CR state has been met based on the received measurement report 500. If so, a CR state decision 502 will be entered. For example, when the measurement report 500 indicates that the network loading has exceeded a network loading threshold, the control center can determine that the CR state decision 502 should be entered.
After entering the CR state decision 502, the control center is configured to send a band information request message 504 to one or more spectrum owners with the potential target frequency bands. The spectrum owners and the target eNB may be in the same or different RAT(s). Also, the spectrum owners and the target eNB may belong to the same or different network operator(s).
Correspondingly, the spectrum owners with the potential target frequency bands respond with the band information response 506 for the frequency band (information on the accessible frequency band) to the control center. The utilization information 506 for the frequency band may include the frequency bands available for rental, the corresponding geographical locations, and the charging rates.
Next, the control center can perform a band selection procedure 508 based on the band information response 506. That is, desired frequency bands can be selected which can meet the requirements for the target eNB. The desired frequency bands may be one or more frequency bands.
If the desired frequency bands are decided upon, the control center can inform (for example, by broadcast or unicast) the target eNB, the neighboring eNB, or the spectrum owner possessing the desired frequency band (with the corresponding spectrum authorization) of the decision result by the band decision message 510.
In response, the target eNB receiving the decision result may request the UE to perform a measurement for the desired frequency band, or utilize the system parameters and then respond the result to the target eNB.
Subsequently, the target eNB which receives the decision result can transmit an acknowledgement message 512 to the control center.
Concurrently, the neighboring eNBs which receive the decision result and other spectrum owners can respond with acknowledgement messages 514 and 516 to the control center. Since the borrowed frequency band may be a frequency band originally assigned to the neighboring eNB, the neighboring eNB is informed that the original assigned frequency band is being borrowed by the target eNB based on the received band decision information 510, and the other neighboring eNBs are informed to not hand over the UE to the borrowed frequency band of the neighboring eNB. Moreover, the control center can re-configure the affected network after receiving the band decision information 510, optimizing the performance of the network based on the newly acquired frequency band.
If no problem is found in the acknowledgement messages from the receiving entities, then the target eNB is configured to enter the CR state 518, and then send the completion messages 520 to the neighboring eNB and the other spectrum owner.

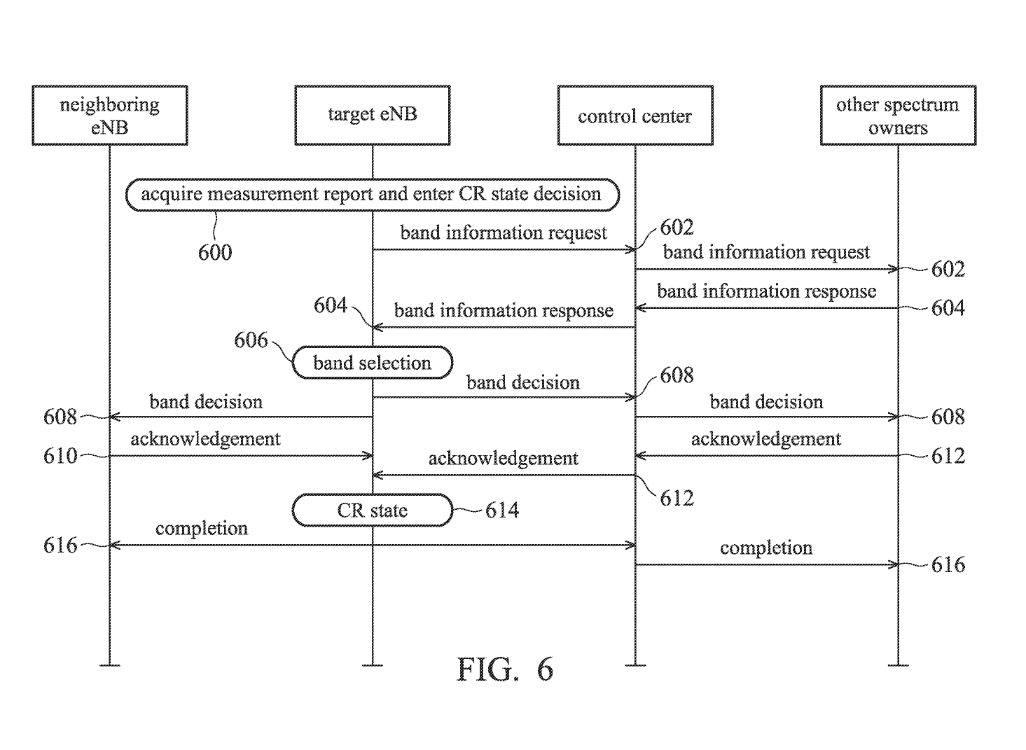

FIG. 6 is a message flow chart of a CR method 6 according to an embodiment of the invention, incorporating the distributed structure in FIG. 4. The CR method 6 depicted by the message flow chart shows the steps for a distributed network infrastructure including the LTE system and other systems to enter the CR state. Those who are skilled in the arts may understand that the control center can be integrated into the target eNB, thus the target eNB may be used to control the flow of the CR technology. With reference to the distributed network infrastructure 4 in FIG. 4, the neighboring eNB may be that the base station 44, the target eNB may be that the base station 40b, the OAM/OSS/EMS control center may be that the NMS 462, and the other spectrum owner may be that the other EMS 464. The neighboring eNB and the target eNB may belong to the same or different RAT(s), also the neighboring eNB and the target eNB may belong to the same or different network operator(s). The spectrum owner and the target eNB may belong to the same or different RAT(s), and the same or different network operator(s).

For the type easel, the protocol for entering the CR state is explained as follows:
Firstly, for all eNBs configured for using the CR technology such as the target eNB, the requirements for entering the CR state are checked based on the traffic measurement reports, and the CR state decision 600 is entered if the requirements for entering the CR state are met. The measurement report may be generated by a measurement conducted by the target eNB itself, or measurements conducted by UEs within the radio coverage and then the measurements may be incorporated by the target eNB. The measurement report may include the network loading and the other radio channel measurements. The requirement for entering the CR state is met when the network loading of the target eNB exceeds a network loading threshold which the target eNB can handle.
If the target eNB meets the requirement(s) for entering the CR state, a request for exchanging information is sent to the neighboring system with different network infrastructure through the ltf S interface, and the band information request message 602 is sent again to the OAM/OSS/EMS control center at the upper layer.
Next, the control center can redirect the band information request message 602 to the other spectrum owner, and receive and forward the corresponding band information response message 604 (information on accessible frequency bands) from the other spectrum owner to the target eNB.
The target eNB can perform a band selection procedure 606 based on the band information response message 604 to select the desired frequency band required by the current cell.
If the desired frequency band is found, the target eNB will inform the control center, the neighboring eNB and the spectrum owner (corresponding authorized user) of the desired frequency band of a frequency band decision message 608 (for example, by way of broadcast or unicast). The frequency band decision message 608 may include the borrowed frequency band and the corresponding geographical location. The OAM/OSS/MES control center may record the borrowed frequency band and the corresponding geographical location. The spectrum owner may later charge the charging rate to the target eNB for the rented frequency band based on the record.
Subsequently, the neighboring eNB and the spectrum owner can properly adjust and optimize the network programs based on the frequency band decision message 608, and respond to the control center with acknowledgement messages 610 and 612.
If no problem is found in the received decision message, the target eNB will enter a CR state 614, and transmit a band adjustment completion message 616, informing the neighboring eNB and other spectrum owners of the decision result.

In the CR state, regardless if the localized or distributed network infrastructures are being used, the control center and the eNB are configured to turn on all associated communication interfaces and receive the frequency band information from other systems in real time; particularly the information on the authorizer possessing the selected desired frequency band.

When leaving the CR state in the localized network infrastructure, if the authorizer of the current desired frequency band sends the information on the desired frequency band (such as the communication for the authorized user is being affected) through the associated interface to the control center, the control center may issue a command of leaving the CR state to the target eNB, then return to the original state or switch to another available frequency band, and respond to the result to the upper layer of the network and the authorizer of the current desired frequency band.

For the type case2, since no associated interface is available for acquiring the information on the available frequency bands, a band sending technique is adopted for obtaining the information. Due to a large amount of data being communicated, the distributed network infrastructure using the target eNB-based control is more likely to adopt the band sending technique. Those skilled in the arts will understand that the control center may be integrated into the target eNB to allow the target eNB to control the flow of the CR method.

In some embodiments, the CR method may adopt a combination of steps disclosed in the CR methods 5 and 6. For example, adopting the steps and messages 600 through 608 from the CR method 6, followed by the control center controlling the successive procedures and adopting the steps and messages 512 through 520 from the CR method 5 to complete the method.

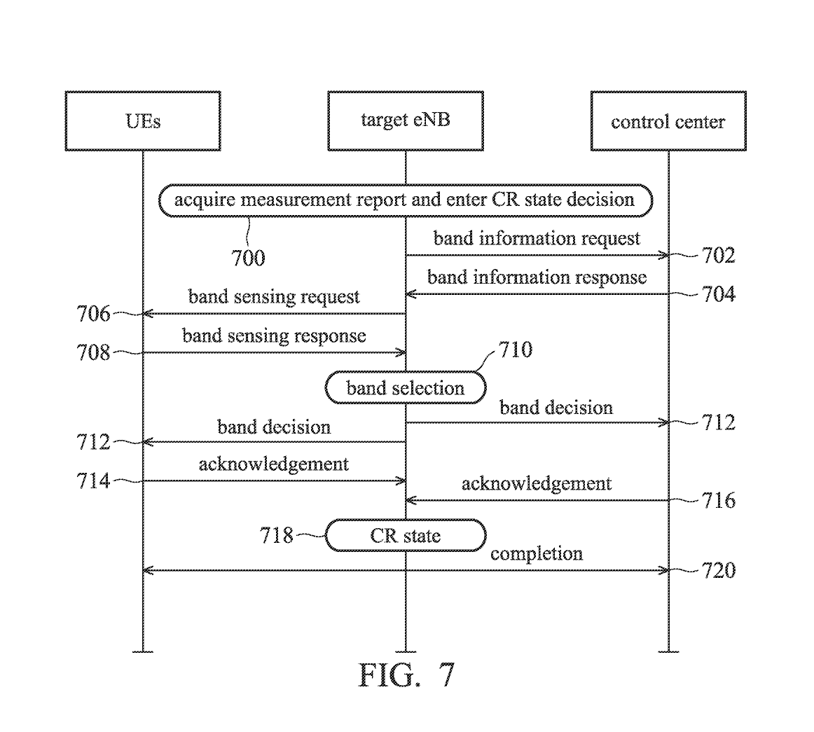

FIG. 7 is a message flow chart of a CR method 7 according to an embodiment of the invention, allowing for entrance to the CR state when no interface is present between the LTE mobile communication system and other systems. The CR method 7 adopts the distributed network infrastructure in FIG. 3. Referring to the distributed network infrastructure 3 in FIG. 4, the UE may be a handset in the cell 30b, the target eNB may be that the base station 30b, the OAM/OSS/EMS control center may be that the NMS 362, and frequency band to be borrowed may be the frequency bands assigned to the other base stations 34 and spectrum owners 38. For example, the base stations 30a and 30b belong to the LTE network, and the base station 34 belongs to the WiMax network. Since no communication interface or channel available between the LTE and WiMax networks, the base station 30b has to adopt the band sensing technique to obtain the information on the available frequency bands.

For the type case2, the protocol for entering the CR state in FIG. 7 is explained as follows:
Firstly, for all eNBs configured for using the CR technology such as the target eNB, the requirements for entering the CR state are checked based on the traffic condition, determining whether the requirements for entering the CR state are met. That is, the eNB configured for the CR technology can measure and enter the CR state decision 700.
If the requirements for entering the CR state are met, the target eNB is configured to transmit a band information request message 702 to the OAM/OSS/EMS control center.
In response to the band information request message 702, the OAM/OSS/EMS control center is configured to respond with information on an available frequency band (information on an accessible frequency band); particularly an associated data structure of the available frequency band and a corresponding detection algorithm.
The target eNB is configured to send a band sensing request message 706, which includes a frequency band to be measured and a corresponding detection algorithm. In some embodiments, the band sensing request message 706 is configured to request the UE to measure the signal strength for certain frequency bands. In other embodiments, the band sensing request message 706 is used to request the UE to sense a behavior or signal characteristic in the target frequency band, e.g., a certain signal shape or signal characteristic of a TV signal.
Correspondingly, the UE is configured to perform a band sensing program and respond with a band sensing result 708 to the target eNB.
The target eNB is configured to incorporate all band sensing results from all UEs and perform a band selection procedure 710, selecting the desired frequency band required by the current cell. For example, the target eNB may select a target frequency band with a signal strength less than a certain signal strength, or a target frequency band conforming to certain signal characteristics.
If the desired frequency band is found, the target eNB can inform (by broadcast or unicast) the control center or the neighboring eNB of the decision outcome via a band decision message 712.
The neighboring eNB and the control center can properly adjust and optimize the network programs based on the frequency band decision message 712, and respond to the control center with acknowledgement messages 714 and 716.
If no problem is found in the received decision message, the target eNB will enter a CR state 718, and inform the neighboring eNB and the control center of a band adjustment completion message 720.

In the CR state, all UE accessible frequency bands are required to be measured; especially for the frequency band in use. When communication for an authorized user using the frequency band is affected (i.e., the frequency band is occupied or a channel condition reduces to below a threshold), the UE is configured to report the condition to the target eNB. In some embodiments, the UE can report to the target eNB information on all frequency bands during every fixed period, allowing the target eNB to make a decision for a backup frequency band.

Furthermore, if the measurement report indicates that the signal strength in the frequency band borrowed from the neighboring eNB has increased, a number of UEs exceeding a UE number threshold have detected primary users, the network loading of the target eNB has decreased to below the network loading threshold, or the cell has not met the requirements for entering the CR state for a certain amount of time, then in the type case2, the target eNB is configured to exit the CR state, returning to the original state. Nevertheless, the target eNB may find a frequency band with a better channel condition, and choose to switch to the frequency band with the better channel condition. Then, the target eNB can inform the upper layer network, and the neighboring eNB of the decision result, and perform the corresponding operations.

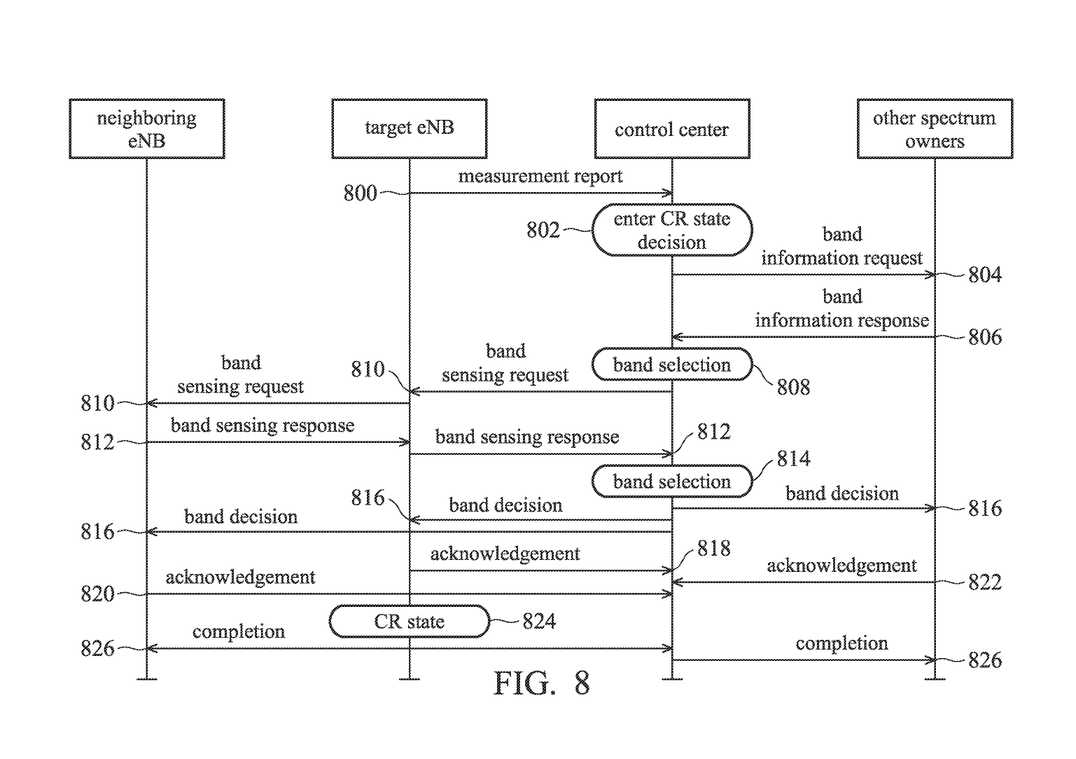

FIG. 8 is a message flow chart of a CR method 8 according to an embodiment of the invention, incorporating the localized network infrastructure in FIG. 2. The CR method 8 shows the message flow chart which depicts the localized network infrastructure with interfaces being present for a part of frequency bands. For the type case3, in the localized network infrastructure, the protocol for entering the CR state is shown in FIG. 8 and explained as follows:
Firstly, for all eNBs configured for using the CR technology such as the target eNB can sent out the traffic condition in the current cell, such as a measurement report 800. The measurement report may be measured by the target eNB itself, or measured by UEs within the radio coverage and then the measurements may be incorporated by the target eNB. The measurement report may include the network loading and the other radio channel measurements.
The control center can determine whether the target eNB has met the requirements for entering the CR state. If so, a CR state decision 802 will be entered. The requirement for entering the CR state may be met when the network loading of the target eNB has exceeded an allowable networking loading threshold.
After entering the CR state decision, the control center can transmit a band information request message 804 to the spectrum owner of the potential frequency bands.
In response to receiving the band information request message 804, the spectrum owner of the potential frequency band can send a band information response message 806 to the control center.
Subsequently, the control center can perform a band selection procedure 808 based on the band information response message 806, selecting the desired frequency band requested by the target eNB.
If the desired frequency band is found, the control center will inform the target eNB, the neighboring eNB or the spectrum owner of the desired frequency band of the selection result. The entities which receive the selection result can respond with a response message. If no problem is detected by the entities, the target eNB is configured to enter the CR state, and inform the associated entities of the result of entering the CR state.
If no desired frequency band is found, the control center can transmit a band sensing request message 810 to the target eNB. The target eNB sends the band information request 804 for all available frequency bands to the database at the upper layer of the network control center. In return, the database responds with a band information response message 806 for all available frequency bands; particularly with the data structure and the corresponding detection algorithm to the target eNB. Then the target eNB issues a band sensing request message 810 and sends the corresponding detection algorithm to the UE in the current cell. In some embodiments, the band sensing request message 806 is used to request the UE to measure the signal strength in certain frequency bands. In other embodiments, the band sensing request message 806 is used to request the UE to sense a behavior or signal characteristic in the target frequency band, e.g., a certain signal shape or signal characteristic of a TV signal.
In response to receiving the band sensing request message 810, the UE is configured to perform a band sensing program and respond with a band sensing result 812 via the target eNB to the control center.
The control center incorporates all band sensing results 812 and performs a band decision procedure 814 to select the desired frequency band required by the current cell.
If the desired frequency band is found, the control center can inform the neighboring eNB, the target eNB and the spectrum owner of the decision result 816 by way of broadcast or unicast.
In response, the target eNB which receives the band decision result 816 is configured to send a response message 818.
The neighboring eNB and spectrum owner can execute appropriate band adjustment and network optimization programs based on the band decision result 816, and respectively respond to the control center with the response messages 820 and 822.
If no problem is detected by the entities, the target eNB can enter the CR state 824, and inform the neighboring eNB and the control center of the band adjustment outcome 826.

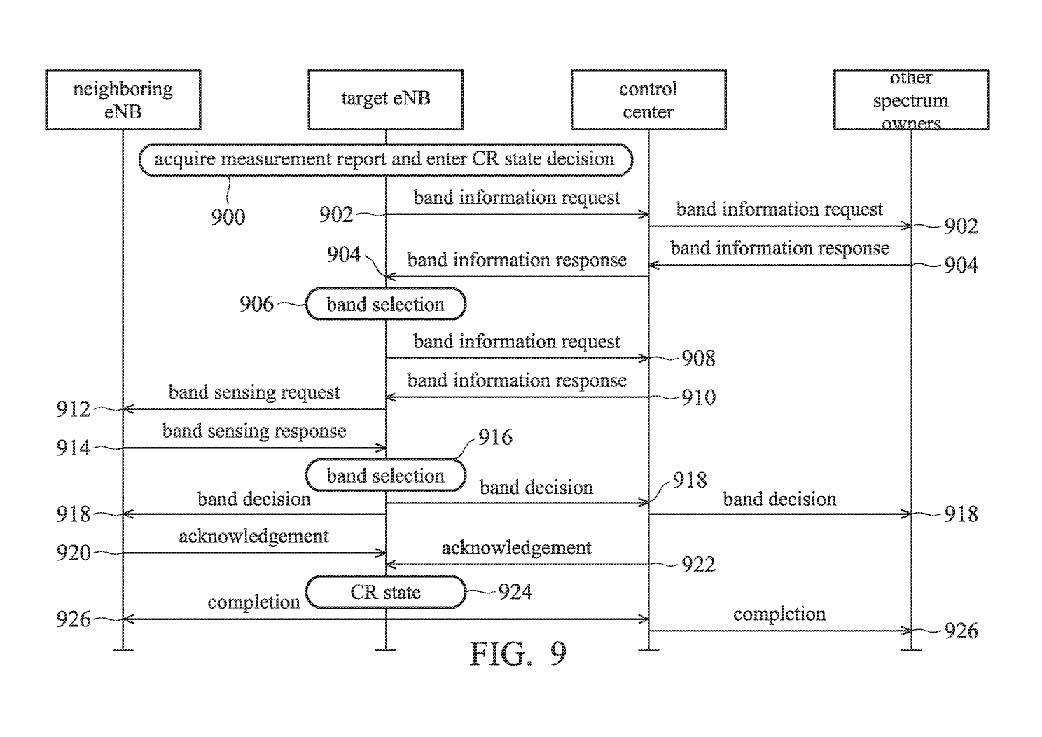

FIG. 9 is a message flow chart of a CR method 9 according to an embodiment of the invention, incorporating the distributed network infrastructure in FIG. 4. The CR method 9 shows a program flow which depicts the distributed network infrastructure with interfaces being present for a part of frequency bands. For the type case3, in the distributed network infrastructure, the protocol for entering the CR state is shown in FIG. 9 and explained as follows:
Firstly, for all eNBs configured for using the CR technology, such as the target eNB, whether the requirements for entering the CR state are met can be determined. If the requirements are met, the eNB can enter the CR state decision procedure 900. The measurement report may be measured by the target eNB itself, or measured by UEs within the radio coverage and then the measurements may be incorporated by the target eNB. The measurement report may include the network loading and the other radio channel measurements. The requirements for entering the CR state may be that the network loading of the target eNB has exceeded an allowable network loading threshold.
If the requirements are met, the target eNB can issue a band information request 902 to the neighboring heterostructure system through the ltf-S interface, and send the band information request 902 to the upper layer of the network control center.
Next, the control center can forward the band information request message 902 to other spectrum owners, and acquire and transfer a band information response message 904 from the other spectrum owners to the target eNB. The band information response message 904 may include information such as frequency bands which can be rented, the corresponding geographical locations, and the charging rates.
Concurrently, in response to the band information request message 902, the neighboring heterostructure system can respond with an associated utilization status and information (not shown) regarding to the frequency band to the target eNB.
The target eNB is configured to enter a band decision procedure 906, selecting the desired frequency band required by the current cell.
If the desired frequency band can be found, the target eNB can inform the upper layer of the network control center, the neighboring eNB or the spectrum owner of the desired frequency band (the corresponding authorized user) of the decision result 918. The entities which receive the informed result can respond with response messages 920 and 922. If the entities find no problem, the target eNB can enter a CR state 924 and report the result.
If no desired frequency is found, the target eNB can transmit all band information requests 908 to the database at the upper layer of the network control center.
The database at the control center can return with a response message 910 for all available frequency bands to the target eNB; especially the data structure and the corresponding detection algorithm.
Correspondingly, the target eNB can send a band sensing request message 912 to the UE in the current cell, along with the corresponding detection algorithm. In some embodiments, the spectrum sending request message 912 is used to request the UE to measure the signal strength in certain frequency bands. In other embodiments, the band sensing request message 912 is used to request the UE to sense a behavior or signal characteristic in the target frequency band, e.g., a certain signal shape or signal characteristic of a TV signal.
In response to receiving the band sensing request message 912, the UE can execute a spectrum sensing program and report a sensing result 914 to the target eNB.
The target eNB incorporates the band sensing results 914 from all UEs and performs a frequency band decision 916 to select the desired frequency band requested by the current cell.
If the desired frequency band can be found, the target eNB can inform the upper layer of the network control center, the neighboring eNB or the spectrum owner of the decision result 918.
The neighboring eNB and the control center can execute appropriate band adjustment and network optimization programs based on the band decision result 918, and respectively respond to the target eNB with the response messages 920 and 922.
If no problem is detected by these entities, the target eNB can enter a CR state, and inform the control center, the neighboring eNB and the spectrum owners of the result.

For the case3 and case2, in localized and distributed network infrastructures in the CR state, the control center and the eNB can turn on the associated communication interfaces and receive band utilization information from other systems in real-time; particularly, the information on the frequency band information that is currently being used by the authorized user. If the eNB in the CR state uses a frequency band in band3, the service UE can perform detection for the accessible frequency bands; especially for the frequency band which is being used by the UE. When the communication of the authorized user using the frequency band is affected (such as when channel quality of the frequency band which is being used has been degraded to below a threshold), the UE can report the condition to the eNB. The UE can report information on all frequency bands to the eNB every period, thereby determining a backup frequency band.

For the case3, the following conditions may occur: the current cell has not met the requirements for entering the CR state for a certain period of time, the authorized user has transmitted a message indicating that it would like to use the current used frequency band through the associated interface to the control center, a time for accessing the current used frequency band has expired, or a number of UEs, which have exceeded a threshold number, have reported that the communication of the authorized user has been affected. When leaving the CR state under the localized network infrastructure, if one or more of the above-described condition occurs, the eNB can use another available frequency band through a frequency band switching procedure, and respond to the result to the upper layer of the network and the authorized user of the current used band. In the distributed network, if the authorized user of the current used frequency band sends a message for using the current used frequency band through the associated interface to the eNB, the eNB can execute a command for leaving the CR state and returning to the original state. If the other conditions occur, the eNB can switch to another available frequency band through the frequency band switching procedure and return the result to the upper layer of the network and the authorized user of the current used band.

The measurement reports measured and provided by the UE or the target eNB, or the band information response message provided from the spectrum owner to the control center in the CR methods 5 through 9 can includes the following frequency band information: the current utilization condition (used or unused), the frequency band/channel identification, the geographical location of the available frequency band, the radio coverage of the frequency band, the range of the frequency band, the bandwidth, the intra-frequency interference indicator, the inter-frequency interference indicator, the time unit per borrowing, the charging rate, and the signal characteristic. The control center can internally establish a database to record the information on the frequency bands. In some embodiments, the control center can look up required information on the frequency band from the database, and issue the band information request message to the spectrum owners to acquire updated band information if no updated band is found. In other embodiments, one or more spectrum owners can transmit updated band information to the control center regularly to maintain the most-updated available band information in the database at the control center.

Embodiments for the band decision methods for an accessed frequency band are provided as follows for the case1, case2 and case3.

Band Decision Procedure

For the case1, the band decision procedure may include:
Step 0: collect information on the available frequency bands by the control center through the interfaces of the mobile communication system and other systems;
Step 1: for all band1s, search for all available frequency bands which met the requirements for the target eNB;
Step 2: if one or more available frequency bands have met the requirements for the target eNB, TB log(1+SNR) is calculated, where T is idle time of the frequency band, B is the bandwidth, and SNR is the signal-to-noise ratio of the frequency band. Select the frequency band with the largest TB log(1+SNR), and perform Step 6;
Step 3: for all band2s, calculate the probability Pr(A>A0), where A0 is a parameter requested by the eNB and A is a parameter associated with the band2. Compare Pr(A>A0) with a predetermined threshold, and list all band2s which meet the requirement for Pr(A>A0) exceeding the predetermined threshold;
Step 4: if one or more frequency bands meet the requirement for Pr(A>A0) exceeding the predetermined threshold, then E{TB log(1+SNR)} is calculated for the one or more frequency bands which meet the requirement, where E{.} represents a mean value, and a frequency band with the largest E{TB log(1+SNR)} is selected, then Step 6 is performed;
Step 5: the requirement for the target eNB is reduced, then Step 1 is performed. For example, the required period of time for the accessed frequency band for the target eNB is set to a half of the original setting, or the predetermined threshold is decreased.
Step 6: the selected frequency band is accessed;
Step 7: a second frequency band according to the same decision rules is selected.

For the case2, the band decision procedure may include:
Step 0: the target eNB downloads the information concerning the frequency band from the system database;
Step 1: for all band3s, the probabilities Pr(A>A0) are respectively calculated and all probabilities are ranked from top to bottom;
Step 2: the band sensing technique is applied to all probabilities from top to bottom based on the ranked order;
Step 3: upon sensing an idle state in a frequency band, the sensing process is stopped and then Step 5 is performed;
Step 4: the requirement for the target eNB is reduced, then Step 1 is performed. For example, the required period of time for the accessed frequency band for the target eNB is set to a half of the original setting, or the predetermined threshold is slightly decreased.
Step 5: the selected frequency band is accessed;
Step 6: a second frequency band is selected according to the same decision rules.

For the case3, the band decision procedure may include:
Step 0: the control center integrates the information on all frequency bands through the interfaces of the mobile communication system and other systems or the database;
Step 1: for all frequency bands in the band1, all available frequency bands which met the requirements for the target eNB are searched;
Step 2: if one or more available frequency bands have met the requirements for the target eNB, TB log(1+SNR) is calculated, where T is idle time of the frequency band, B is the bandwidth, and SNR is the signal-to-noise ratio of the frequency band. The frequency band with the largest TB log(1+SNR) is selected, and Step 9 is performed;
Step 3: for all frequency bands in the band2, the probabilities Pr(A>A0) are calculated, where A0 is a parameter requested by the eNB and A is a parameter associated with the band2. All Pr(A>A0) are compared with a predetermined threshold, and all band2s which meet the requirement for Pr(A>A0) exceeding the predetermined threshold are listed;
Step 4: if one or more frequency bands meet the requirement for Pr(A>A0) exceeding the predetermined threshold, then E{TB log(1+SNR)} is calculated for the one or more frequency bands which meet the requirement, where E{.} represents a mean value, and a frequency band with the largest E{TB log(1+SNR)} is selected, then Step 9 is performed.
Step 5: for all frequency bands in the band3, respectively, the probabilities Pr(A>A0) are calculated and all probabilities from top to bottom are ranked;
Step 6: the band sensing technique is applied to all probabilities from top to bottom based on the ranked order;
Step 7: upon sensing an idle state in a frequency band, the sensing process and Step 9 are performed;
Step 8: the requirement for the target eNB is reduced, then Step 1 is performed. For example, the required period of time for the accessed frequency band for the target eNB is set to a half of the original setting, or the predetermined threshold is slightly decreased.
Step 9: the selected frequency band is accessed;
Step 10: second frequency band is selected according to the same decision rules.

When the target eNB decides upon the frequency band for use and enters the CR state, then the selected frequency band may be utilized. The utilization for different frequency bands may be different according to the application conditions. The spectrum utilization procedure is provided as follows.

Spectrum Utilization Procedure

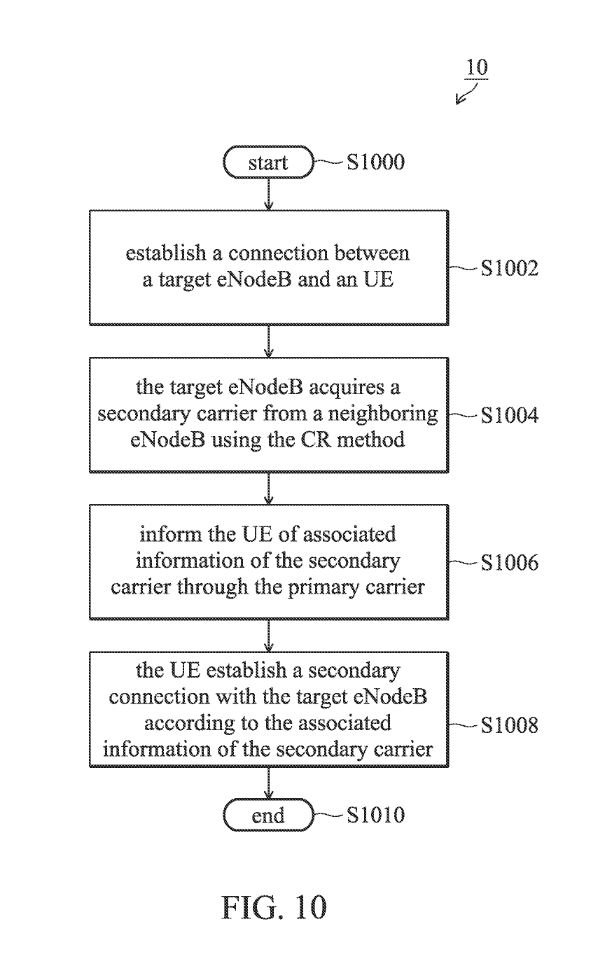

The methods based on the LTE system utilizing the CR methods include carrier aggregation. FIG. 10 is a flowchart of a carrier aggregation method 10 according to an embodiment of the invention, incorporating the communication systems 2 through 4 and the CR methods 5 through 9.

When adopting the carrier aggregation technique to implement the CR method, the target eNB for the CR technique can acquire a non-original authorization frequency band based on the

CR methods disclosed by the embodiments. Upon startup of the carrier aggregation, the target eNB can establish a connection to the UE through an authorized frequency band originally assigned thereto (S1002), obtain a frequency band for a secondary carrier using the CR method disclosed by the embodiments (S1004), then inform the UE of the RF parameter and assigned information for the secondary carrier (such as the central frequency, bandwidth or system information) through the primary carrier (such as via an RRC control signaling) (S1006). The frequency of the secondary carrier does not belong to the original authorized frequency bands, and the information on the frequency band adopted by the secondary carrier may be obtained by the control center or by the band sensing technique. After the target eNB acquires the authorization from the control center or automatically decides on using the frequency band for the secondary carrier, the eNB can request the terminal to activate the non-original authorized frequency band, and proceed with the data transmission until deactivation of the secondary carrier (S1008). The target eNB can also request the UE to measure a specific frequency for the non-original authorized frequency band, and report the result through the primary carrier. The target eNB has to deactivate the secondary carrier before the authorization of the target frequency band expires to prevent from impacting the communication of the authorized user in the target frequency band. If the terminal detects that the communication of the authorized user in the target frequency band has been affected after the activation of the secondary carrier, the target eNB has to deactivate the secondary carrier in advance. Because the utilization of the secondary carrier is more flexible, it is very suitable to use the CR method for the acquiring of the frequency band for the secondary carrier. When the secondary carrier is required to be deactivated due to the expired authorization, the UE user will not experience a disconnection in communications, therefore positive user experience can be increased.

The carrier aggregation method in FIG. 10 enables the target eNB to utilize the CR technology to establish a secondary carrier connection when network capacity is insufficient, increasing network capacity, while deactivating the frequency band for the secondary carrier before the authorization expires without negatively impacting user experience.

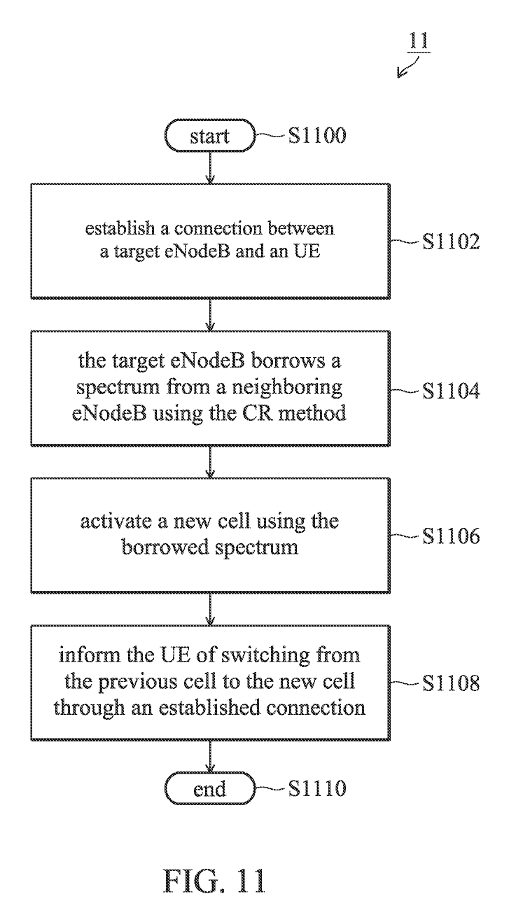

FIG. 11 is a flowchart of an inter-frequency handover method 11 according to an embodiment of the invention, incorporating the communication systems 2 through 4 and the CR methods 5 through 9.

The inter-frequency handover method in FIG. 11 is adopted by a target eNB with multiple RF antennas, providing multiple frequency bands for establishing connections to the UE. The UE may be a communication device with single antenna. Upon startup of the inter-frequency handover method 11 (S1100), the target eNB employs the authorized frequency bands assigned thereto to establish a connection by a first antenna to the UE (S1102). When the network capacity is insufficient, the target eNB can borrow a frequency band from any neighboring eNB based on the CR methods disclosed in the embodiments (S1104), and initiate a new cell by a second antenna of the target eNB using the borrowed frequency band (S1106), and inform the UE to be handed over to the new cell via the established connection (S1108). Accordingly, upon receiving the handover message, the UE can be handed over to the new established cell using the borrowed frequency band, thereby completing the inter-frequency handover program for the target eNB (S1110).

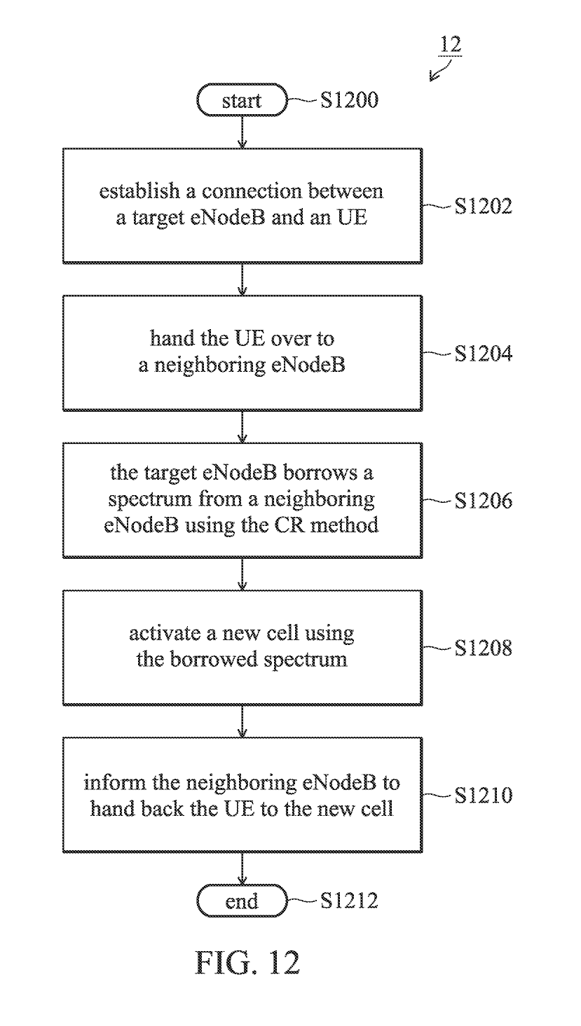

FIG. 12 is a flowchart of an inter-frequency switching method 12 according to an embodiment of the invention, incorporating the communication systems 2 through 4 and the CR methods 5 through 9.

The inter-frequency handover method in FIG. 11 is adopted by a target eNB with single RF antenna. Upon startup of the inter-frequency handover method 12 (S1200), the target eNB employs the authorized frequency bands assigned thereto to establish a connection to the UE (S1202). When the network capacity is insufficient, the target eNB can transfer the UE to a neighboring eNB having enough network capacity firstly (S1204). Then the target eNB can borrow a frequency band from any neighboring eNB based on the CR methods disclosed in the embodiments (S1206). The borrowed frequency band from the neighboring eNB may be a frequency band with an increased network capacity. The target eNB can next initiate a new cell using the borrowed frequency band (S1208), and inform the handover neighboring eNB to hand the UE back to the new cell (S1210). Accordingly, the neighboring eNB can hand over the UE back to the new cell of the target eNB to complete the inter-frequency handover program (S1212).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for implementing a cognitive radio (CR) technology, comprising:
when a first base station meets a requirement for entering a cognitive radio (CR) state, acquiring information on a potential frequency band which is assigned to a second base station;
performing a band selection based on the potential frequency band to select a desired frequency band; and
entering the CR state by accessing the first base station using the desired frequency band.

2. The method of claim 1, wherein coverage of the first base station is overlapped with that of the second base station.

3. The method of claim 1, further comprising:
determining, by the first base station, whether the first base station meets the requirement for entering the CR state based on a measurement report; and
acquiring, by the first base station, the information on the potential frequency band from a database for the band selection.

4. The method of claim 3, wherein the measurement report is provided by:
measuring, by the first base station, a transmission condition in an original cell in service; or
measuring and reporting, by a user equipment, the transmission condition in the original cell to the first base station.

5. The method of claim 3, wherein acquiring the information on the potential frequency band assigned to the second base station comprises:
transmitting, by the first base station, a band information request to a control center;
receiving, by the first base station, a band information response from the control center; and
performing, by the first base station, the band selection based on the band information response.

6. The method of claim 5, wherein acquiring the information on the potential frequency band assigned to the second base station further comprises:
transmitting, by the first base station, a band sensing request to an entity;
receiving, by the first base station, a band sensing response; and
performing, by the first base station, the band selection based on the band information response and the band sensing response.

7. The method of claim 6, wherein the entity is a neighboring base station of the first base station or a user equipment.

8. The method of claim 1, further comprising:
receiving, by a control center, a measurement report on whether the first base station meets the requirement for entering the CR state; and
receiving, by the first base station, the desired frequency band from the control center;
wherein the control center acquires the information on the potential frequency band from a database and performs the band selection to produce the desired frequency band

9. The method of claim 8, wherein the measurement report is provided by:
measuring, by the first base station, a transmission condition in an ordinary service coverage; or
measuring and reporting, by a user equipment, the transmission condition in an ordinary service coverage to the first base station.

10. The method of claim 9, wherein acquiring the information on the potential frequency band comprises:
receiving, by the first base station, the desired frequency band selected by the control center;
transmitting, by the control center, a band information request to other spectrum owners;
receiving, by the control center, a band information response from the other spectrum owners; and
performing, by the control center, the band selection based on the band information response and the information on the potential frequency band acquired from the database, to determine the desired frequency band.

11. The method of claim 10, further comprising:
transmitting, by the control center, a band sensing request to the first base station;
performing, by the first base station, a band sensing procedure; and
responding, by the first base station, a band sensing response to the control center;
wherein the control center obtains the desired frequency band based on the band information response and the band sensing response.

12. The method of claim 1, wherein entering the CR state comprises:
when the first base station enters the CR state, activating a new cell based on a part of the desired frequency band; and
transmitting or receiving, by a terminal, a signal to or from the first base station via the original cell and the new cell.

13. The method of claim 1, wherein entering the CR state comprises:
when the first base station enters the CR state, activating a new cell using a part of the desired frequency band; and
handing over a terminal to the new cell as to regard the new cell as a service cell for the terminal.

14. The method of claim 1, wherein entering the CR state comprises:
before the first base station enters the CR state, handing over, by the first base station, a service cell for a terminal to a neighboring cell;
during the CR state, terminating, by the first base station, an original service cell for the terminal; and
during the CR state, activating a new cell using a part of the desired frequency band, switching the service cell for the terminal to the new cell, and providing services, by the first base station, to the terminal through the new cell.

15. The method of claim 1, wherein the requirement for entering the CR state comprises at least one of the following, a current band utilization, a band/channel identification, a geometrical location of a serviceable frequency band, a radio coverage of the serviceable frequency band, a band range, a bandwidth of the band, an in-band interference index, a duration available for lending, a lending rate and a signal characteristic.

16. The method of claim 1, wherein the performing a band selection based on the potential frequency band to select the desired frequency band step comprises:
determining the desired frequency band according to a duration available for lending, a bandwidth, and a signal-to-noise ratio of the potential frequency band.

17. A device, adopting a cognitive radio (CR) technology, comprising:
a first element management unit, when a first base station meets a requirement for entering a CR state, transmitting a request of entering the CR state;
a network management unit, coupled to the first element management unit, receiving the request of entering the CR state from the first element management unit; and
a second element management unit, coupled to the network management unit and the first element management unit, acquiring information on a potential frequency band which is assigned to a second base station,
wherein the network management unit performs a band selection based on the potential frequency band to select the desired frequency band, and responds to the request of entering the CR state, enabling the first base station to enter the CR state and establish a connection using the desired frequency band.

18. The device of claim 17, wherein radio coverage of the first base station is overlapped by that of the second base station.

19. The device of claim 18, wherein:
the network management unit selects the desired frequency band based on the information on the potential frequency band and a database; and
the database comprises a management and maintenance database stored in the network management unit, or the database is a base station database stored in a base station controller.

20. The device of claim 19, wherein the network management unit determines whether the requirement for entering the CR state is met based on a measurement report.

21. The method of claim 20, wherein:
the network management unit transmits a band information request to the second element management unit;
the network management unit receives a band information response from the second element management unit; and
the network management unit performs the band selection based on the band information response and the database.

22. The method of claim 21, wherein:
the network management unit further transmits a band sensing request to a neighboring base station;
the network management unit receives a band sensing response from the neighboring base station; and
the network management unit performs the band selection based on the band information response, the band sensing response and the database.
